(19) United States
(12) Patent Application Publication
(10) Pub. No.: US 2003/0157453 A1
(43) Pub. Date: Aug. 21, 2003

(54) Boat for heat treatment and vertical heat treatment apparatus

(76) Inventors: Shinji Irie, Tokyo-To (JP); Hirofumi Sakai, Tokyo-To (JP)

Correspondence Address: SMITH, GAMBRELL & RUSSELL, LLP, 1850 M STREET, N.W., SUITE 800, WASHINGTON, DC, 20036, US

(21) Appl. No.: 10/366,374

(22) Filed: Feb. 14, 2003

(30) Foreign Application Priority Data
Feb. 19, 2002 (JP) 2002-042253

(51) Int. Cl. F27D 3/00

(52) U.S. Cl. 432/239; 432/241; 432/253

(57) ABSTRACT

A plurality of side posts (12) and a plurality of rear posts (13) are disposed on the opposite sides S and on the rear side R of the workpiece (W), respectively. The side posts (12) and the rear posts (13) are provided with grooves (14, 15) having workpiece support surfaces (14a, 15a) and formed at predetermined vertical intervals, respectively. Each support surface of each side posts (12) is formed in a wide width and extends along the circumference of the workpiece from the center axis C of the workpiece toward the front side F on the front side of the workpiece (W). Each of the support surfaces (14a, 15a) of the posts (12, 13) inclines down toward the center axis C of the workpiece.

### TECHNICAL FIELD

The present invention relates to a boat for heat treatment and a vertical heat treatment apparatus.

### BACKGROUND ART

In fabricating a semiconductor device, workpieces, such as semiconductor wafers, are subjected to various thermal processes, such as an oxidation process, a diffusion process, a chemical vapor deposition process and an annealing process. A vertical heat treatment apparatus capable of simultaneously thermal-processing a plurality wafers is one of heat treatment apparatuses for carrying out those thermal processes. The vertical heat treatment apparatus uses a boat for heat treatment for holding a plurality of wafers.

Referring to FIG. 9, an ordinary boat for heat treatment is provided with side posts 30 provided with grooves 32 respectively having support surfaces 32a on which opposite side parts of wafers W are seated, and a rear post 31 provided with grooves 33 respectively having support surfaces 33a on which rear parts of the wafers W are seated. The wafers W are stacked vertically (in a direction perpendicular to the paper) on the boat and are supported on the side posts 30 and the rear post 31. The support surfaces 32a and 33a are substantially horizontal. Front parts of the wafers W on the front side of a line connecting the side posts 30, i.e., on the side of the front side F (the right side as viewed in FIG. 9), are open to enable a transfer mechanism to load the wafers W into and to unload the same from the boat for heat treatment.

An overhanging part Oa, namely, a part projecting toward the front side F beyond the line connecting the posts 30, of each of the wafers W held on the boat for heat treatment is large. Therefore, stress is concentrated on parts of the wafer W corresponding to the support surfaces 32a (particularly, the edges of the support surfaces 32a) of the side posts 30. Consequently, flaws are liable to be formed in the back surfaces of the wafers W, and the flaws cause slips (defects in crystals) when the wafers W are subjected to a thermal process.

Position and length of a slip are related with the position of a flaw formed in the back surface of the wafer and the magnitude of stress. The deeper the flaw or the greater the stress, the more a slip is likely to occur from the flaw. FIG. 10 shows a slip starting point Sa in a wafer W. A flaw is formed in a region of a predetermined range α (α=about 7 to about 8 mm) from the edge into a device region, and a slip starts from the flaw. Slips deteriorate the quality of products and reduces yield. There is a tendency that slips occur particularly in a large wafer of, for example 300 mm in diameter when the wafer is processed for a thermal process at high temperatures on the order of 1000° C.

Slip control techniques proposed in, for example, JP9-50967A and JP10-22228A employ wide side posts extending from a position corresponding to the center of a wafer toward the front side, and having wafer support surfaces of a long circumferential length extending along the circumferences of wafers. However, those prior art slip control techniques are not necessarily satisfactory in effects in preventing the formation of flaws in parts of the back surface corresponding to the device region of the wafer and controlling the occurrence of slips. Moreover, there is the possibility that wafers held on the conventional boat for heat treatment are caused to slide out of position toward the front side (open side) by vibrations and fall off the boat for heat treatment.

### DISCLOSURE OF THE INVENTION

The present invention has been made in view of the foregoing circumstances and it is therefore an object of the present invention to provide a boat for heat treatment capable of holding workpieces without flawing parts of the back surface of the workpiece corresponding to a device region of the same, of limiting a region in which slops occur to a peripheral part of the workpiece and of preventing the workpiece from falling off, and to provide a vertical heat treatment apparatus.

A boat for heat treatment comprises a plurality of posts including at least side posts disposed at side positions on opposite sides of workpieces and rear posts disposed at positions on a rear side of the workpieces; wherein each of the posts is provided with grooves having support surfaces on which the workpieces are seated, and formed at predetermined vertical intervals, each of the support surfaces of each of the side posts extends along the circumference of the workpiece toward the front side on the front side of the workpiece, and each of the support surfaces of the posts inclines down toward the center axis of the workpiece.

In the boat for heat treatment according to the present invention, the workpieces have the shape of a disk, and each support surface of each of the side posts has the shape of a circular arc extending along the circumference of the workpiece and forming a central angle in the range of 5° to 45°.

In the boat for heat treatment according to the present invention, each support surface of each of the side posts extends along the circumference of the workpiece from a center line perpendicular to a straight line passing the center of the workpiece and connecting the front and the rear sides of the workpiece to the front side, and has the shape of a circular arc forming a central angle in the range of 5° to 45°.

In the boat for heat treatment according to the present invention, the number of the rear posts is three or above.

The boat for heat treatment according to the present invention is formed of silicon carbide.

The boat for heat treatment according to the present invention has surfaces coated with a protective film formed by a CVD process.

In the boat for heat treatment according to the present invention, front end parts of the support surfaces of the side posts are chamfered.

In the boat for heat treatment according to the present invention, the inclination of the support surfaces of the posts is in the range of 5° to 15°.

A vertical heat treatment apparatus in another aspect of the present invention comprises a boat for heat treatment for holding workpieces, comprises a plurality of posts including at least side posts disposed at side positions on opposite sides of workpieces and rear posts disposed at positions on a rear side of the workpieces; wherein each of the posts is provided with grooves having support surfaces on which the workpieces are seated, and formed at predetermined vertical intervals, each of the support surfaces of each of the side posts extends along the circumference of the workpiece toward the front side on the front side of the workpiece, and each of the support surfaces of the posts inclines down toward the center axis of the workpiece.

In the vertical heat treatment apparatus according to the present invention, the workpieces have the shape of a disk, and each support surface of each of the side posts has the shape of a circular arc extending along the circumference of the workpiece and forming a central angle in the range of 5° to 45°.

In the vertical heat treatment apparatus according to the present invention, each support surface of each of the side posts extends along the circumference of the workpiece from a center line perpendicular to a straight line passing the center of the workpiece and connecting the front and the rear sides of the workpiece to the front side, and has he shape of a circular arc forming a central angle in the range of 5° to 45°.

In the vertical heat treatment apparatus according to the present invention, the number of the rear posts is three or above.

In the vertical heat treatment apparatus according to the present invention, the boat for heat treatment is formed of silicon carbide.

In the vertical heat treatment apparatus according to the present invention surfaces of the boat for heat treatment are coated with a protective film formed by a CVD process.

In the vertical heat treatment apparatus according to the present invention, front end parts of the support surfaces of the side posts are chamfered.

In the vertical heat treatment apparatus according to the present invention, the inclination of the support surfaces of the posts is in the range of 5° to 15°.

### BRIEF DESCRIPTION OF THE DRAWINGS

FIG. 1 is a longitudinal sectional view of a vertical heat treatment apparatus in a preferred embodiment according to the present invention;

FIG. 2 is a plan view of a boat for heat treatment employed in the vertical heat treatment apparatus shown in FIG. 1;

FIG. 3 is a cross-sectional view of the boat for heat treatment;

FIG. 4 is an enlarged sectional view taken on line A-A in FIG. 2;

FIG. 5 is an enlarged sectional view of a part B in FIG. 4;

FIG. 6 is an enlarged view taken in the direction of the arrow C in FIG. 4;

FIG. 7 is a cross sectional view showing a wafer supported on the boat for heat treatment;

FIG. 8A is a view showing a slip starting point on a wafer;

FIG. 8B is a sectional view taken on line D-D in FIG. 8A;

FIG. 9 is a cross-sectional view of a prior art boat for heat treatment supporting a wafer; and

FIG. 10 is a view showing a slip starting point on a wafer.

### BEST MODE FOR CARRYING OUT THE INVENTION

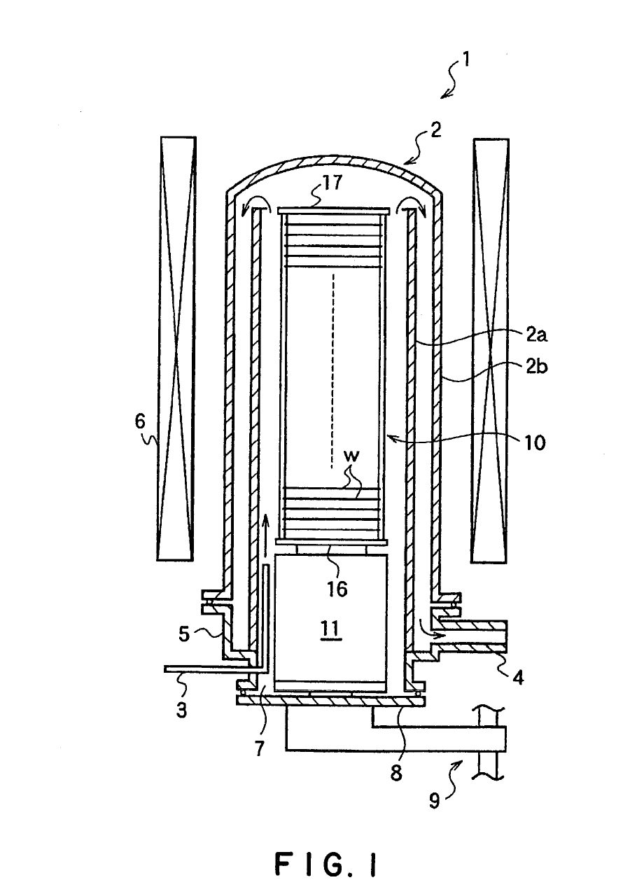

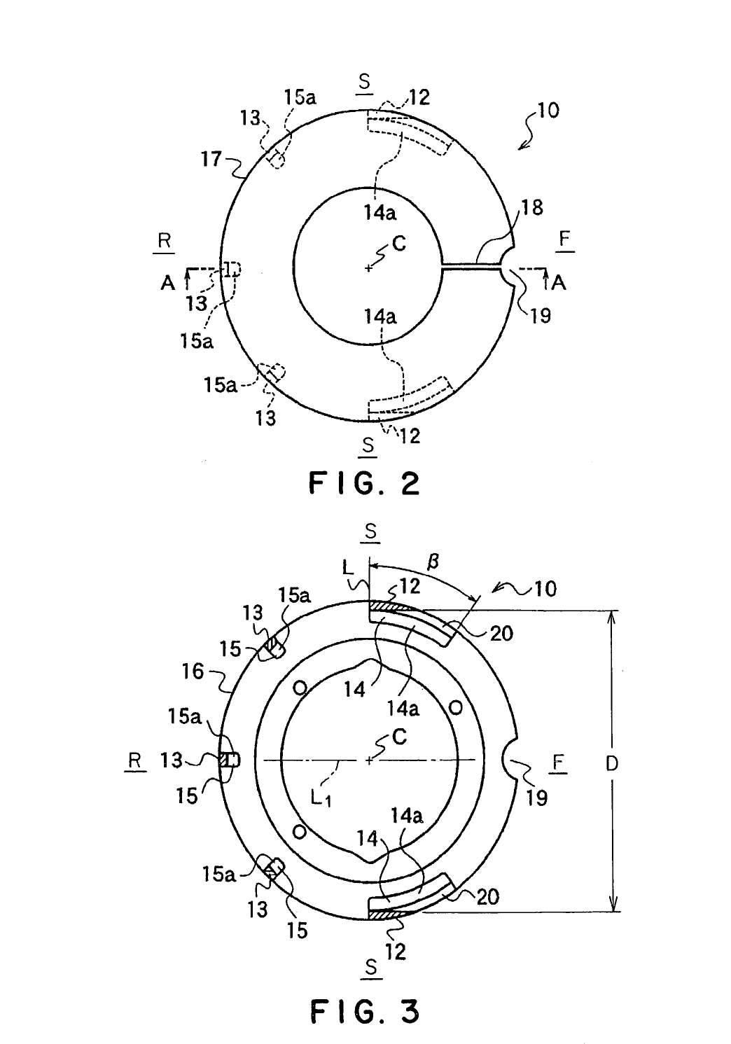

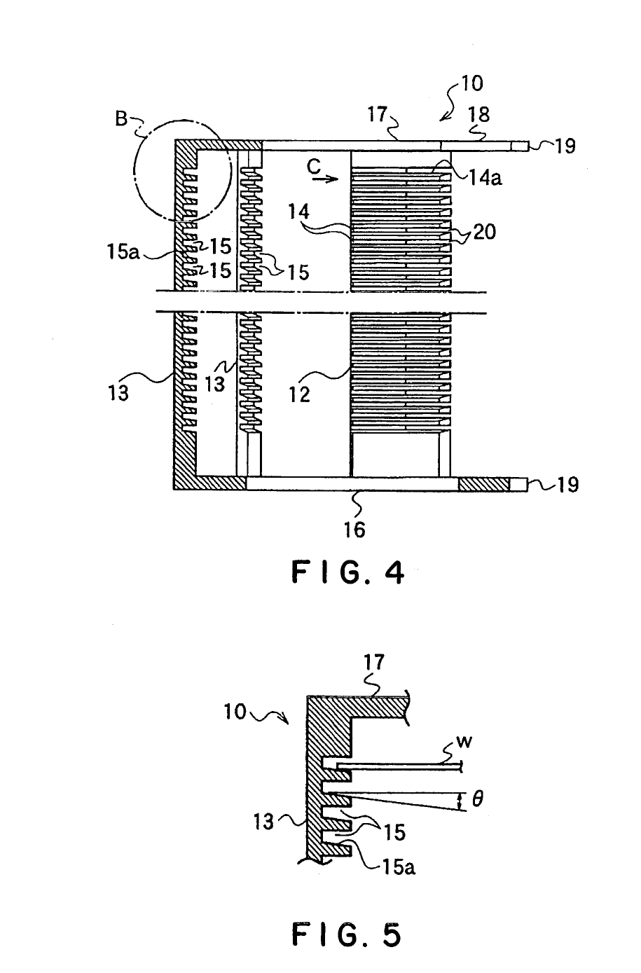

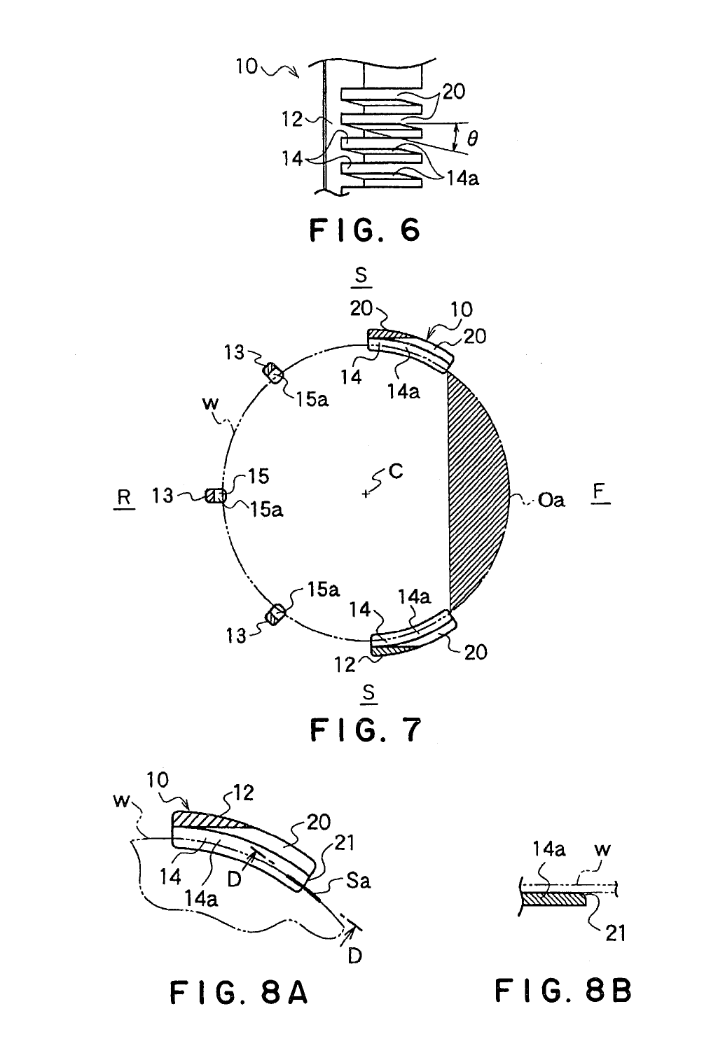

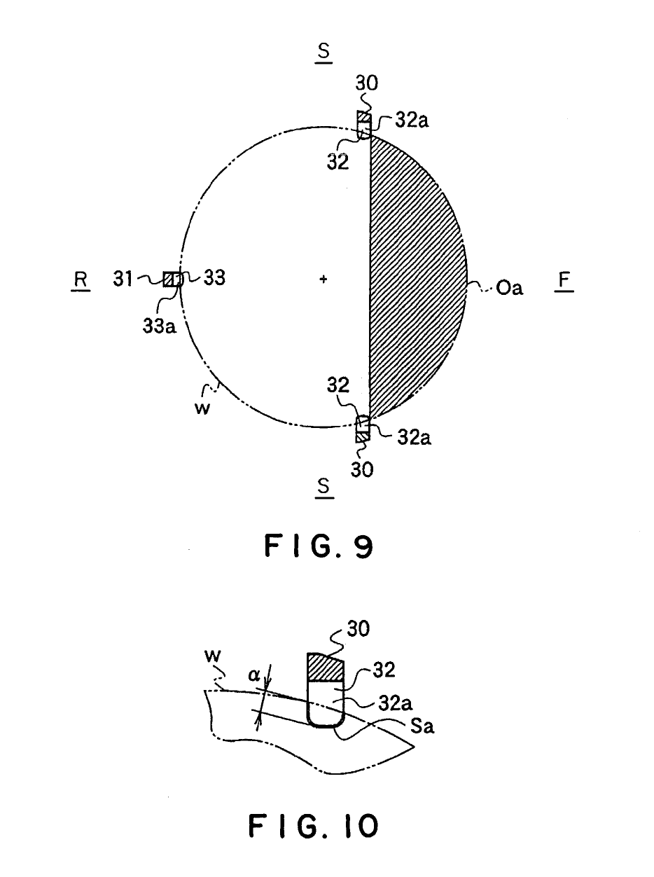

Preferred embodiments of the present invention will be described with reference to the accompanying drawings. FIG. 1 is a longitudinal sectional view of a vertical heat treatment apparatus in a preferred embodiment according to the present invention, FIG. 2 is a plan view of a boat for heat treatment employed in the vertical heat treatment apparatus, FIG. 3 is a cross-sectional view of the boat for heat treatment, FIG. 4 is an enlarged sectional view taken on line A-A in FIG. 2, FIG. 5 is an enlarged sectional view of a part B in FIG. 4, and FIG. 6 is an enlarged view taken in the direction of the arrow C in FIG. 4.

Referring to FIG. 1, a vertical heat treatment apparatus 1 is provided with a quartz reaction tube 2, i.e., a processing vessel serving as a thermal-processing furnace for containing workpieces having the shape of a thin disk, such as semiconductor wafers W, therein for a predetermined thermal process, such as a CVD process. The reaction tube 2 shown in FIG. 1 is a double-wall structure consisting of an inner tube 2a and an outer tube 2b. The reaction tube 2 may be a single-wall structure consisting of only the outer tube 2b. An annular manifold 5 is connected hermetically to a lower end part of the reaction tube 2. The manifold 5 is provided with a gas supply pipe (gas inlet port) for supplying a process gas and a purging inert gas into the reaction tube 2, and a gas discharge pipe (discharge port) 4 for discharging gases from the reaction tube 2.

The gas supply pipe 3 is connected to a pipe, not shown, included in a gas supply system. The gas discharge pipe 4 is connected to a pipe, not shown, included in a discharge system including a vacuum pump for evacuating the reaction tube 2, a pressure control valve and such. The manifold 5 is mounted on a base plate, not shown. A cylindrical heater 6 is disposed so as to surround the reaction tube 2. The heater 6 is capable of controlling the temperature of the interior of the reaction tube 2 in the range of, for example, 300° C. to 1200° C.

The manifold 5 joined to the lower end of the reaction tube 2 has an opening 7 serving as a furnace mouth. A cover 8 for covering the opening 8 is moved vertically by a lifting mechanism 9. The cover 8 is raised and is brought into close contact with the open lower end of the manifold 5 to close the opening 7.

An insulating tube 11 is mounted on the cover 8, and a boat for heat treatment (referred also to as “boat”) 10 is mounted on the insulating tube 11. The boat 10 is capable of supporting seventy-five to hundred large wafers W of, for example, 300 mm in diameter having the shape of a disk in a horizontal position at vertical intervals. The boat 10 is loaded (carried) into the reaction tube 2 by raising the cover 8 by the lifting mechanism 9. The boat 10 is unloaded (carried out) from the reaction tube 2 by lowering the cover 8.

Referring to FIGS. 2 to 6, the boat 10 is provided with a plurality of side posts 12 disposed on the opposite sides S of the wafers W, and a plurality of rear posts 13 disposed on the rear side R of the wafers W. Each of the side posts 12 is provided with grooves 14 respectively having wafer support surfaces (workpiece support surfaces) 14a. Each of the rear posts 13 is provided with grooves 15 respectively having wafer support surfaces (workpiece support surfaces) 15a. The grooves 14 and 15 are arranged vertically at predetermined intervals. The boat 10 includes a bottom plate 16, a top plate 17, and the posts 12 and 13 extended between the bottom plate 16 and the top plate 17.

The posts 12 and 13 are arranged circumferentially at predetermined angular intervals so as to surround the wafers W. Front parts of the wafers W on the side of the front side F with respect to a line connecting the side posts 12 are open to enable a transfer mechanism, not shown, to load the wafers into and to unload the same from the boat 10. The rear posts 13, three posts in this embodiment, are arranged on the side of the rear side R to distribute stress imparted to peripheral parts of the wafers W. Preferably, the rear posts 13 are arranged at equal angular intervals. The posts 12 and 13 are joined to the bottom plate 16 and the top plate 17 by, for example, welding.

Each of the bottom plate 16 and the top plate 17 has an annular shape. Preferably, the top plate 17 is provided with a slit 18 to relieve thermal stress on the top plate 17 when the boat 10 is used for a thermal process using high temperatures. In this embodiment, cuts 19 are formed in peripheral parts of the bottom plate 16 and the top plate 17, respectively, to avoid interference between the plates 16, 17 and a rod-shaped temperature measuring device, not shown, inserted through the cover in the furnace to measure temperature in the furnace in setting an initial condition.

The side posts (also referred to as “open-side posts”) 12 on the side of the sides S and the wafer support surfaces 14a thereof extend in a wide width toward the side of the front side F with respect to the center axis C of the wafers W, which is aligned with the center axis of the boat 10. Each of the wafer support surfaces 14a extends along the circumference of the wafer W. As shown in FIG. 3, each wafer support surface 14a of each of the side posts 12 extends along the circumference of the wafer W from a transverse center line L perpendicular to a straight line L1 passing the center C of the wafer W and connecting a front end (front side) of the wafer W on the side of the front side F and a rear end (rear side) of the same on the side of the rear side R toward the front side in a circular arc, and has a central angle β in the range of 5° to 45°. Preferably, the central angle β is about 35°, and each of the side posts 12 has a cross-sectional shape resembling a circular arc corresponding to the shape of the wafer support surface 14a. The posts 12 are provided with the grooves 14, and slits 20 opening toward the front side F are formed in the opposite side posts 12 so that a space of a width D that permits the passage of the wafer W is formed between the corresponding grooves 14 of the opposite side posts 12.

The respective wafer support surfaces 14a and 15a of the posts 12 and 13 incline down toward the center axis C of the wafer W so that the peripheral edge of the lower surface of the wafer W comes into line contact with the wafer support surfaces 14a and 15a to prevent the wafer W from being forced to slip horizontally toward the front side F by vibrations or the like and from slipping off or falling off the boat 10. Preferably, the wafer support surfaces 14a and 15a incline down toward the center axis C of the wafer W at a predetermined inclination θ in the range of, for example, 5° to 15°, desirably, about 10° to prevent flawing parts, corresponding to a device region of the wafer W, of the back surface of the wafer W.

Although the boat 10 may be formed of quartz if the boat 10 is used at moderately high process temperatures not higher than 1000° C., it is preferable to form the boat 10 of a silicon carbide (SiC) when the boat is used at comparatively high process temperatures in the range of, for example, about 1050° C. to about 1200° C. It is preferable that the surfaces of the boat 10 is coated with a protective film formed by, for example, a CVD process to prevent the wafer W from being contaminated with low-purity silicon carbide.

In the boat 10 for heat treatment or the vertical heat treatment apparatus 1 employing the boat 10 for heat treatment, the side posts 12 disposed on the side of the opposite sides S and the rear posts 13 disposed on the side of the rear side R are provided with the grooves 14 and 15 having wafer support surfaces 14a and 15a, respectively, to hold, for example about seventy-five to about hundred wafers W in a vertical stack at predetermined intervals. Each of the side posts 12 extends in a wide width toward the side of the front side F with respect to the center axis C of the wafers W so that the wafer support surface 14a extends along the circumference of the wafer W, and the respective wafer support surfaces 14a and 15a of the side posts 12 on the side of the opposite sides S and the rear posts 13 on the side of the rear side R incline down toward the center axis C of the wafer W. Thus, the flawing of parts of the back surfaces of the wafers W corresponding to device regions can be prevented, the peripheral edges of the lower surfaces of the wafers W can be seated on the wafer support surfaces 14a and 15a in line contact with the wafer support surfaces 14a and 15a, and hence the wafers W can be prevented from being forced to slip and to fall off the boat 10 by vibrations or the like.

Since each wafer support surface 14a of each of the side posts 12 extends along the circumference of the wafer W toward the front side F in a long circular arc, stress induced by the own weight of the wafer W can be distributed. Since an overhanging part Oa projecting toward the front side F beyond the line connecting the front ends of the wafer support surfaces 14a of the opposite side posts 12 is small as shown in FIG. 7, stress induced in parts of the wafer W corresponding to the front ends of the wafer support surfaces 14a of the side posts 12 by the weight of the overhanging part Oa can be controlled or reduced. Since the wafer support surfaces 14a slope down toward the center axis C of the wafer W, the peripheral edge of the lower surface of the wafer W can be seated on the wafer support surfaces 14a of the side posts 12 in line contact with the wafer support surfaces 14a as shown in FIG. 8A. Thus, the flawing of parts of the back surface of the wafer W corresponding to the device region can be prevented, parts in which slip occurs or slip starting points Sa can be limited to the circumferential edge of the wafer W and, consequently, the quality and yield of the wafers W can be improved. The occurrence of slip in the circumferential edge of the wafer W can be further effectively controlled by beveling (chamfering) or rounding the front edges of the wafer support surfaces 14a of the side posts 12 as indicated at 21 in FIG. 8B.

Since the respective wafer support surfaces 14a and 15aof the side posts 12 on the side of the opposite sides S and the rear posts 13 on the side of the rear side R incline down toward the center axis C of the wafer W, the wafer W tends to slide along the sloping wafer support surfaces 14a and 15a toward the center axis C and thereby the wafer W is located properly. Therefore, the wafer W does not slip laterally out of position even if the wafer W is subjected to vibrations and shocks when the boat 10 holding the wafer W is moved and stopped for loading and unloading operations or the wafer W is subjected to vibrations due to air currents generated when the pressure of the interior of the reaction tube 2 is reduced or returned to the normal pressure or to vibrations due to earthquakes. Thus, the wafer W can be prevented from lateral slipping and slipping off the boat 10 and from breakage due to falling, and earthquake-proof property, durability and reliability can be improved.

Although the preferred embodiments of the present invention have been described with reference to the accompanying drawings, the present invention is not limited to the foregoing embodiments in its practical application, and various changes in design may be made without departing from the scope of the present invention. For example, the heat treatment apparatus is not limited to CVD systems, and may be a system for an oxidation process, a diffusion process, an annealing process or the like. Although silicon carbide is a preferable material of the boat, the boat may be formed of polycrystalline silicon (Si). The workpieces are not limited to semiconductor wafers and may be, for example, LCD substrates.

Briefly, the present invention has the following effects.

According to the present invention, in the boat provided with the plurality of side posts and the plurality of rear posts disposed on the side of the opposite sides and on the side of the rear side, respectively, of the workpieces, and provided with the grooves having the workpiece support surfaces and formed at predetermined vertical intervals to support the plurality of workpieces in a vertical stack, each of the workpiece support surfaces of each of the side posts are formed in a wide width so as to extend along the circumference of the workpiece toward the front side with respect to the center axis of the workpiece. Since the workpiece support surfaces of the side posts and the rear posts incline down toward the center axis of the workpiece, the flawing of the parts of the back surface of the workpiece corresponding to the deice region can be prevented, parts where slip occurs can be limited to the circumferential edge of the workpiece and the workpiece can be prevented from slipping off the boat.

The boat for heat treatment of the present invention formed of silicon carbide is suitable for use for processes that use high temperatures.

Since the protective film is formed by the CVD process over the surfaces of the boat for heat treatment according to the present invention, the workpieces can be prevented from contamination by the boat.

According to the present invention, since the front edges of the workpiece support surfaces of the boat according to the present invention are chamfered, the occurrence of slip in the circumferential edges of the workpieces can be further effectively controlled.

According to the present invention, the workpiece support surfaces are sloped down at an inclination in the range of 5° to 15°, flawing of parts of the back surface of the workpiece corresponding to the device region can be prevented, parts where slip occurs can be limited to the circumferential edge of the workpiece, and the workpiece support surfaces are able to exhibit satisfactory effect in preventing the workpiece from slipping off the boat.

According to the present invention, in the vertical heat treatment apparatus provided with the boat for heat treatment provided with the plurality of side posts and the plurality of rear posts disposed on the side of the opposite sides and on the side of the rear side, respectively, of the workpieces, and provided with the grooves having the workpiece support surfaces and formed at predetermined vertical intervals to support the plurality of workpieces in a vertical stack, each of the workpiece support surfaces of each of the side posts are formed in a wide width so as to extend along the circumference of the workpiece toward the front side with respect to the center axis of the workpiece. Since the workpiece support surfaces of the side posts and the rear posts slope down toward the center axis of the workpiece, the flawing of the parts of the back surface of the workpiece corresponding to the deice region can be prevented, parts where slip occurs can be limited to those in the circumferential edge of the workpiece and the workpiece can be prevented from slipping off the boat.

The boat for heat treatment of the present invention formed of silicon carbide is suitable for use for processes that use high temperatures.

Since the protective film is formed by the CVD process over the surfaces of the boat for heat treatment according to the present invention, the workpieces can be prevented from contamination by the boat.

According to the present invention, since the front edges of the workpiece support surfaces of the boat according to the present invention are chamfered, the occurrence of slip in the circumferential edges of the workpieces can be further effectively controlled.

According to the present invention, the workpiece support surfaces are sloped down at an inclination in the range of 5° to 15°, flawing of parts of the back surface of the workpiece corresponding to the device region can be prevented, parts where slip occurs can be limited to those in the circumferential edge of the workpiece, and the workpiece support surfaces are able to exhibit satisfactory effect in preventing the workpiece from slipping off the boat.

What is claimed is:

1. A boat for heat treatment for holding workpieces, comprises: a plurality of posts including at least side posts disposed at side positions on opposite sides of workpieces and rear posts disposed at positions on a rear side of the workpieces;
wherein each of the posts is provided with grooves having support surfaces on which the workpieces are seated, and formed at predetermined vertical intervals,
each of the support surfaces of each of the side posts extends along the circumference of the workpiece toward the front side on the front side of the workpiece, and
each of the support surfaces of the posts inclines down toward the center axis of the workpiece.

2. The boat for heat treatment according to claim 1, wherein
the workpieces have the shape of a disk, and each support surface of each of the side posts has the shape of a circular arc extending along the circumference of the workpiece and forming a central angle in the range of 5° to 45°.

3. The boat for heat treatment according to claim 2, wherein
each support surface of each of the side posts extends along the circumference of the workpiece from a center line perpendicular to a straight line passing the center of the workpiece and connecting the front and the rear sides of the workpiece to the front side, and has the shape of a circular arc forming a central angle in the range of 5° to 45°.

4. The boat for heat treatment according to claim 1, wherein
the number of the rear posts is three or above.

5. The boat for heat treatment according to claim 1, wherein
a material forming the boat for heat treatment is silicon carbide.

6. The boat for heat treatment according to claim 1, wherein
surfaces of the boat is coated with a protective film formed by a CVD process.

7. The boat for heat treatment according to claim 1, wherein
front end parts of the support surfaces of the side posts are chamfered.

8. The boat for heat treatment according to claim 1, wherein
the inclination of the support surfaces of the posts is in the range of 5° to 15°.

9. A vertical heat treatment apparatus comprising a boat for heat treatment for holding workpieces;
wherein the boat is comprises a plurality of posts including at least side posts disposed at side positions on opposite sides of workpieces and rear posts disposed at positions on a rear side of the workpieces,
each of the posts is provided with grooves having support surfaces on which the workpieces are seated, and formed at predetermined vertical intervals,
each of the support surfaces of each of the side posts extends along the circumference of the workpiece toward the front side on the front side of the workpiece, and
each of the support surfaces of the posts inclines down toward the center axis of the workpiece.

10. The vertical heat treatment apparatus according to claim 9, wherein
the workpieces have the shape of a disk, and each support surface of each of the side posts has the shape of a circular arc extending along the circumference of the workpiece and forming a central angle in the range of 5° to 45°.

11. The vertical heat treatment apparatus according to claim 10, wherein
each support surface of each of the side posts extends along the circumference of the workpiece from a center line perpendicular to a straight line passing the center of the workpiece and connecting the front and the rear sides of the workpiece to the front side, and has the shape of a circular arc forming a central angle in the range of 5° to 45°.

12. The vertical heat treatment apparatus according to claim 9, wherein
the number of the rear posts is three or above.

13. The vertical heat treatment apparatus according to claim 9, wherein
the boat for heat treatment is formed of silicon carbide.

14. The vertical heat treatment apparatus according to claim 9, wherein
surfaces of the boat for heat treatment are coated with a protective film formed by a CVD process.

15. The vertical heat treatment apparatus according to claim 9, wherein
front end parts of the support surfaces of the side posts are chamfered.

16. The vertical heat treatment apparatus according to claim 9, wherein
the inclination of the support surfaces of the posts is in the range of 5° to 15°.
